(19) United States
(12) Patent Application Publication
(10) Pub. No.: US 2007/0230380 A1
(43) Pub. Date: Oct. 4, 2007

(54) System And Method For Selecting A Point-To-Point Or Point-To-Multipoint Transmission Mode

(75) Inventors: Karl Olof Joakim Bergstrom, Stockholm (SE); Peter Hans Edlund, Tumba (SE); Jacques Sagne, Paris (FR)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/568,592

(22) PCT Filed: May 3, 2005
(86) PCT No.: PCT/EP05/52030

§ 371 Date: Mar. 5, 2007

(30) Foreign Application Priority Data
May 7, 2004 (SE) 0401210-0

(51) Int. Cl. H04Q 7/24

(52) U.S. Cl. 370/310

(57) ABSTRACT

A system and method in a wireless telecommunication system such as a Universal Mobile Telephone System, UMTS, for selecting whether to utilize either a point-to-multipoint, PTM, or a point-to-point, PTP, connection to send media content to User Equipments, UEs, (11) present in a cell in the wireless telecommunication system. A Controlling Radio Network Controller (25) makes this decision and notifies an involved Serving RNC (26). The SRNC receives the PTM/PTP decision from the CRNC and determines whether the PTM/PTP decision is valid for a given UE connection.

### FIELD OF THE INVENTION

The present invention relates to wireless telecommunication systems. More particularly, and not by way of limitation, the present invention is directed to a system and method for selecting whether to utilize a point-to-point transmission mode or a point-to-multipoint transmission mode in a Universal Mobile Telephone System (UMTS)-based telecommunication system.

### BACKGROUND OF THE INVENTION

Release 6 of the Third Generation Partnership Project (3GPP) defines a Multimedia Broadcast Multicast Service (MBMS). The specification defines two modes of operation, a broadcast mode and a multicast mode. The present invention relates to the multicast mode.

In the multicast mode, two different transmission modes may be utilized by the UMTS Terrestrial Radio Access Network (UTRAN) for media content delivery to interested users: a point-to-multipoint (PTM) mode and a point-to-point (PTP) mode. In the PTM mode, a media stream is broadcast on a common channel received by a number of users. The PTM mode is of primary interest when a large number of users in a given cell wish to receive the same media content. In this case, transmission resources (codes, transmit power, and the like) saved by avoiding duplication of the data stream on different radio bearers may outweigh the transmit power overhead required for common channel transmission. In the PTP mode, on the other hand, user data is delivered to each user individually using a dedicated traffic channel. The PTP mode is of primary interest when only a few users in the cell are interested in the same media content.

The entity in charge of the logical resources of the cells in the UMTS network is known as a Controlling Radio Network Controller (CRNC). The CRNC decides on a per cell basis whether PTM or PTP transmission shall be utilized for delivery of the MBMS content. Although the algorithm used in this process is not standardized, a typical implementation would take as an input, the number of User Equipments (UEs) that are present in a given cell and are interested in that service. The algorithm selects PTM transmission whenever a predefined threshold number of UEs is reached. Otherwise, the PTP mode is selected.

The entity in charge of the UE connection in the UMTS network is known as a Serving RNC (SRNC). The SRNC/CRNC decide on a per UE connection basis whether PTM or PTP transmission should apply for delivery of the MBMS content. If the SRNC selects PTP transmission for an identified UE, a dedicated radio bearer is set up towards this UE, which requires that the MBMS data stream being delivered to the UE originate from the SRNC. Conversely, if the SRNC selects PTM transmission, no dedicated resources are established. This means that the UE receives the data stream on common channels originating from the CRNC. It should be noted that depending on whether soft/selective combining techniques are used, the UE may have to simultaneously listen to common channels belonging to different cells. A more detailed description of the UTRAN can be found, e.g., in the document 3GPP TS 25.401 issued by the 3^{rd} Generation Partnership Project.

The UMTS interface between different CRNCs and SRNCs is the Iur interface. The current 3GPP specifications do not describe any functional division between different logical entities with regard to PTM/PTP negotiation over the Iur interface. Thus, PTM/PTP decision information is not adequately shared between the SRNC and the CRNC. This results in inefficiencies in the network because the PTM/PTP decisions made by the SRNC may have a direct impact on the resource utilization in cells controlled by the CRNC.

### SUMMARY OF THE INVENTION

The present invention addresses the problem in which a CRNC must decide to apply either a point-to-point (PTP) connection or a point-to-multipoint (PTM) connection and communicate this decision to an involved SRNC. The present invention solves this problem by a functional division between different logical entities with regard to PTM/PTP negotiations over the Iur interface in order to achieve an increased flexibility.

Thus, in one aspect the present invention is directed to a method of selecting whether to utilize a PTM transmission mode or a PTP transmission mode in a wireless telecommunication system. The method includes making a PTM/PTP decision in a CRNC to utilize either the PTM transmission mode or the PTP transmission mode to send media content to User Equipments (UEs) present in a cell in the wireless telecommunication system; and notifying an SRNC of the PTM/PTP decision.

In another aspect, the present invention is directed to a CRNC in a wireless telecommunication network. The CRNC includes means for making a PTM/PTP decision to utilize either the PTM transmission mode or the PTP transmission mode to send media content to UEs present in a cell in the wireless telecommunication system. The CRNC also includes means for notifying an SRNC of the PTM/PTP decision.

In yet another aspect, the present invention is directed to a system in a wireless telecommunication network for selecting whether to utilize the PTM transmission mode or the PTP transmission mode. The system includes a CRNC adapted to make a PTM/PTP decision to utilize either the PTM transmission mode or the PTP transmission mode to send media content to UEs present in a cell in the wireless telecommunication system. The system also includes an SRNC adapted to receive the PTM/PTP decision from the CRNC and to determine whether the PTM/PTP decision is valid for a given UE connection.

### BRIEF DESCRIPTION OF THE DRAWINGS

FIG. 1 shows an example of a PTM/PTP negotiation enabled by the method according to the present invention; and

FIG. 2 is a simplified block diagram of one embodiment of the system of the present invention.

### DESCRIPTION OF THE INVENTION

In a distributed architecture, two types of algorithms may be utilized for PTM/PTP negotiation over Iur. The first is a CRNC PTM/PTP decision algorithm located in the CRNC, and the second is an SRNC PTM/PTP decision algorithm located in the SRNC. There is one instance of the SRNC PTM/PTP decision algorithm per UE context. The process by which CRNC(s) and the SRNC interact for deciding whether PTM or PTP transmission shall apply for a particular UE connection is referred to herein as PTM/PTP negotiation over Iur.

CRNC PTM/PTP Decision Algorithm

With regard to the CRNC PTM/PTP decision algorithm, different embodiments are possible. According to one embodiment of the present invention, there is one instance of the CRNC PTM/PTP decision per cell. In such a scheme, the CRNC sends PTM/PTP decisions, per cell, to the SRNC.

According to another embodiment of the present invention, there is one instance of the locally coordinated CRNC PTM/PTP decision per drift UE context. In this scheme, PTM/PTP decisions are notified per drift UE context to the SRNC. For the particular case of a UE in CELL_DCH state and having an established PTP MBMS RAB in softcombining for two cells in the CRNC, the PTM/PTP decision, which has been received by the SRNC, is therefore valid for all radio links that are part of the UE connection and located in the CRNC. On the other hand, for a UE in CELL_DCH due to a PS_RAB, i.e. non-MBMS service, in softcombining with two radio links in cells under the control of the CRNC, it is not by default required that softcombining shall also be applied for MBMS in the same cells as the radio links for the PS RAB. The algorithm utilized by the CRNC to derive a PTM/PTP decision per drift UE context may receive as inputs, for example, parameters such as the PTM/PTP status, and the congestion status of the cell-part of the connection (UE in CELL_DCH state).

In order to notify the SRNC of the relevant CRNC PTM/PTP decision algorithm state transitions, the CRNC may include PTM/PTP decision information in the following messages over the Iur interface: RADIO LINK SETUP RESPONSE, RADIO LINK SETUP FAILURE, RADIO LINK ADDITION RESPONSE, and RADIO LINK ADDITION FAILURE. The PTM/PTP decision information may also be sent in the MBMS CHANNEL TYPE RECONFIGURATION INDICATION message. This message may apply to UEs in states other than CELL_DCH, so it utilizes the connectionless mode of the signaling bearer.

Relevant state transitions within the CRNC PTM/PTP decision algorithm(s) may be sent to the SRNC PTM/PTP decision algorithm, either internally (i.e., when the CRNC is co-located with the SRNC), or through Iur-signaling (i.e., when the CRNC is not co-located with the SRNC). It should also be noted that both decision schemes (i.e., PTM/PTP decision per cell or PTM/PTP decision per drift UE context) may be utilized in parallel by the CRNC. The CRNC/SRNC PTM/PTP decision algorithms are defined per MBMS service and can be based on various criterions, e.g. based on decisions for other radio links that are combined in the CRNC, based on a required/desired Quality-of-Service, etc. Thus, if the UE receives several MBMS services simultaneously, different instances of the CRNC/SRNC PTM/PTP decision algorithms may run in parallel, both in the CRNC and in the SRNC. Different schemes (per cell or per connection) may be used for different MBMS services in the CRNC. In the SRNC the decision algorithm is applied for coordination functions, e.g. in view of softcombining considerations.

When the SRNC receives notifications of state transitions within the various CRNC PTM/PTP decision algorithms, the SRNC PTM/PTP decision algorithm determines the PTP/PTM decision that is valid for the whole UE connection for all UEs served by the CRNC and in all possible states, in particular CELL_DCH. The SRNC PTM/PTP algorithm may consider parameters such as, for example, the PTM/PTP decision notifications (received either internally or via Iur signaling) and the network resources.

SRNC PTM/PTP Decision Algorithm

The PTM/PTP algorithm in the SRNC decides whether to utilize PTM or PTP transmission for a particular UE connection. Such a scheme may benefit from receiving feedback from the CRNC since the PTM/PTP decision made by the SRNC may have a direct impact on the resource utilization in cells controlled by the CRNC. By combining information received from the various CRNC(s) involved in the connection, the SRNC then decides whether to utilize the PTM mode or PTP mode. Upon state transitions within the SRNC PTM/PTP decision algorithm, the SRNC may engage required reconfiguration procedures towards the Drift Radio Network Controller(s) (DRNCs).

Example Decision Process

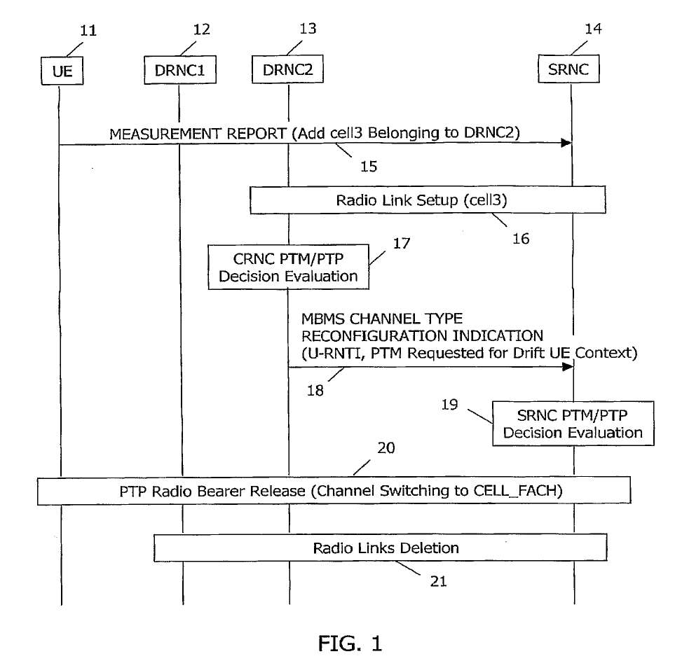

FIG. 1 is a signaling diagram illustrating the flow of messages between the various entities in the UTRAN during a typical PTM/PTP negotiation enabled by a system utilizing a distributed architecture. In the illustrated example, a UE 11 is in state CELL_DCH with a PS Interactive/Background RAB+MBMS bearer PTP established. The UE is in soft handover in cell1 (belonging to DRNC1 12) and in cell2 (belonging to DRNC2 13). The DRNCs negotiate with an SRNC 14. Furthermore, it is assumed that the PTM/PTP status (as decided by the CRNC PTM/PTP decision algorithms) of the cells part of the active set is as follows:
cell1→PTP, cell2→PTM.

The process begins when the UE 11 requires the addition of cell3 (belonging to DRNC2 13) to the active set. Thus the UE sends a MEASUREMENT REPORT 15 to the SRNC 14 requesting to add cell3 belonging to DRNC2. At step 16, a radio link is set up in cell3. In this case, the PTM/PTP status of cell3 is assumed to be PTM. At step 17, the CRNC PTM/PTP decision algorithm is run in DRNC2 per drift UE context (in this example). It is furthermore assumed that the outcome of the algorithm is PTM (thus leading to a state transition). DRNC2 then sends an MBMS CHANNEL TYPE RECONFIGURATION INDICATION message 18 over the Iur interface to the SRNC notifying the SRNC of the CRNC PTM/PTP decision state transition, and requesting PTM for the drift UE context. This message is sent connectionless. At step 19, the SRNC PTM/PTP decision algorithm is run in the SRNC. It is assumed that the outcome is PTM (thus leading to a state transition).

At step 20, the MBMS PTP radio bearer is released internally within UTRAN, and towards the UE. The UE is moved to CELL_FACH state due to the remaining PS Interactive/Background RAB. Finally, at step 21, DRNC1 12, DRNC2 13, and the SRNC 14 within the UTRAN delete radio links.

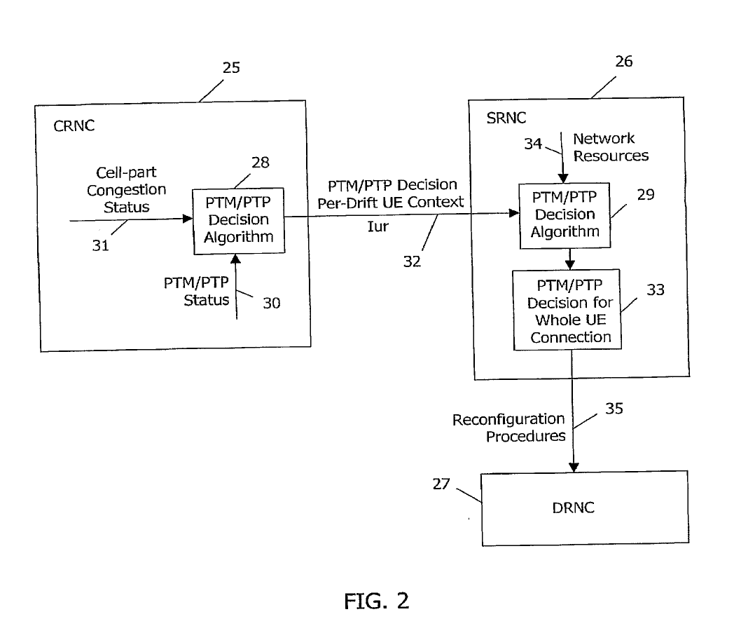

FIG. 2 is a simplified block diagram of one embodiment of the system of the present invention. The illustrated network entities include a CRNC 25, an SRNC 26, and a DRNC 27. The CRNC includes a PTM/PTP decision algorithm 28, and the SRNC includes a PTM/PTP decision algorithm 29. The CRNC PTM/PTP decision algorithm receives as inputs, parameters such as the PTM/PTP status 30, and the congestion status of the cell-part of the connection 31 (UE in CELL_DCH state). In this exemplary embodiment, the CRNC sends PTM/PTP decisions per drift UE context to the SRNC over the Iur interface 32.

When the SRNC 26 receives notifications of state transitions within the CRNC PTM/PTP decision algorithm 28, the SRNC PTM/PTP decision algorithm 29 determines the PTM/PTM decision that is valid for the whole UE connection 33. In addition to the CRNC PTM/PTP decision notifications, the SRNC PTM/PTP algorithm may consider parameters such as network resources 34 when determining the valid PTM/PTP decision. The SRNC may also engage required reconfiguration procedures 35 towards the DRNC 27.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1-22. (canceled)

23. A method of selecting whether to utilize a point-to-point (PTP) transmission mode or a point-to-multipoint (PTM) transmission mode in a wireless telecommunication system, said method comprising:
making a PTM/PTP decision in a Controlling Radio Network Controller (CRNC) to utilize either the PTM transmission mode or the PTP transmission mode to send media content to User Equipments (UEs) present in a cell in the wireless telecommunication system, and
notifying a Serving Radio Network Controller (SRNC) of the PTM/PTP decision.

24. The method according to claim 23, wherein the PTM/PTP decision is made per cell.

25. The method according to claim 23, wherein the PTM/PTP decision is made per drift UE context.

26. The method according to claim 25, wherein the step of making a PTM/PTP decision includes considering at least the current PTM/PTP status and congestion status.

27. The method according to claim 23, wherein the PTM/PTP decision is made simultaneously for a plurality of services, and PTM/PTP decisions are made in parallel on both a per cell basis and a per drift UE context basis.

28. The method according to claim 23, further comprising determining by the SRNC, whether the PTM/PTP decision is valid for a given UE connection.

29. The method according to claim 28, wherein the step of determining by the SRNC whether the PTM/PTP decision is valid for a given UE connection includes considering at least the PTM/PTP decision received from the CRNC and network resources available.

30. The method according to claim 23, wherein the wireless telecommunication system is a Universal Mobile Telephone System (UMTS)-based telecommunication system operating in a multicast mode.

31. The method according to claim 30, wherein the step of notifying the SRNC of the PTM/PTP decision includes notifying the SRNC of the PTM/PTP decision over an Iur interface between the CRNC and the SRNC.

32. The method according to claim 31, wherein the step of notifying the SRNC of the PTM/PTP decision over the Iur interface includes sending the PTM/PTP decision in a message selected from a group consisting of:
a RADIO LINK SETUP RESPONSE message;
a RADIO LINK SETUP FAILURE message;
a RADIO LINK ADDITION RESPONSE message; and
a RADIO LINK ADDITION FAILURE message.

33. The method according to claim 31, wherein the step of notifying the SRNC of the PTM/PTP decision over the Iur interface includes utilizing a connectionless mode of a signaling bearer to send the PTM/PTP decision in a MBMS CHANNEL TYPE RECONFIGURATION INDICATION message, for UEs in states other than CELL˜DCH.

34. The method according to claim 23, wherein the step of notifying the SRNC of the PTM/PTP decision includes notifying the SRNC of the PTM/PTP decision utilizing internal signaling when the CRNC and the SRNC are co-located.

35. A Controlling Radio Network Controller (CRNC) in a wireless telecommunication network, said CRNC comprising:
means for making a PTM/PTP decision to utilize either a point-to-point (PTP) transmission mode or a point-to-multipoint (PTM) transmission mode to send media content to User Equipments (UEs) present in a cell in the wireless telecommunication system; and
means for notifying a Serving Radio Network Controller (SRNC) of the PTM/PTP decision.

36. The CRNC according to claim 35, wherein the means for making a PTM/PTP decision is adapted to make the PTM/PTP decision on a per cell basis.

37. The CRNC according to claim 35, wherein the means for making a PTM/PTP decision is adapted to make the PTM/PTP decision on a per cell basis.

38. The CRNC according to claim 37, wherein the means for making a PTM/PTP decision is adapted to consider at least the current PTM/PTP status and congestion status.

39. The CRNC according to claim 35, wherein the means for making a PTM/PTP decision is adapted to make the PTM/PTP decision simultaneously for a plurality of services, and to make PTM/PTP decisions in parallel on both a per cell basis and a per drift UE context basis.

40. A system in a wireless telecommunication network for selecting whether to utilize a point-to-point (PTP) transmission mode or a point-to-multi point (PTM) transmission mode, said system comprising:
a Controlling Radio Network Controller (CRNC) adapted to make a PTM/PTP decision to utilize either a point-to-point (PTP) transmission mode or a point-to-multipoint (PTM) transmission mode to send media content to User Equipments (UEs) present in a cell in the wireless telecommunication system; and
a Serving Radio Network Controller (SRNC) adapted to receive the PTM/PTP decision from the CRNC and to determine whether the PTM/PTP decision is valid for a given UE connection.

41. The system according to claim 40, wherein the CRNC is adapted to notify the SRNC of the PTM/PTP decision over an Iur interface between the CRNC and the SRNC.

42. The system according to claim 41, wherein the CRNC is adapted to notify the SRNC of the PTM/PTP decision over the Iur interface by sending the PTM/PTP decision in a message selected from a group consisting of:
a RADIO LINK SETUP RESPONSE message;
a RADIO LINK SETUP FAILURE message;
a RADIO LINK ADDITION RESPONSE message; and
a RADIO LINK ADDITION FAILURE message.

43. The system according to claim 41, wherein the CRNC is adapted to notify the SRNC of the PTM/PTP decision over the Iur interface by utilizing a connectionless mode of a signaling bearer to send the PTM/PTP decision in a MBMS CHANNEL TYPE RECONFIGURATION INDICATION message, for UEs in states other than CELL˜DCH.

44. The system according to claim 40, wherein the CRNC and the SRNC are co-located, and the CRNC is adapted to notify the SRNC of the PTM/PTP decision utilizing internal signaling.
